(19) United States
(12) Patent Application Publication
(10) Pub. No.: US 2015/0078178 A1
(43) Pub. Date: Mar. 19, 2015

(54) SOFTWARE PLATFORM FOR IMPLEMENTATION AND CONTROL OF SATELLITE COMMUNICATION SYSTEMS

(71) Applicant: Tachyon Networks Incorporated, San Diego, CA (US)

(72) Inventors: Peter Alexander Carides, San Diego, CA (US); Marc S. Janov, San Diego, CA (US)

(73) Assignee: Tachyon Networks Incorporated, San Diego, CA (US)

(21) Appl. No.: 14/027,992

(22) Filed: Sep. 16, 2013

(51) Int. Cl. H04W 24/08

(52) U.S. Cl. CPC H04W 24/08
USPC 370/252

(57) ABSTRACT

A software-based technology framework for supervising and supporting a combined wireless and satellite communications network requires a two-way communication capability that is operated by a network manager in a supervising system. In particular, this requires the monitoring of a communication network by the network manager, which receives operational information from operative components in the communications network that is pertinent to state/status, performance, and fault reporting aspects of the components. The operational information is then correlated and analyzed at the network manager to generate support information, which pertains to administration, configuration, provisioning and troubleshooting instructions for operative components of the communication network. The support information is then disseminated by the network manager to the appropriate operative component.

### FIELD OF THE INVENTION

The present invention pertains generally to systems that supervise and support the operation of satellite and wireless communication networks. More particularly, the present invention pertains to supervising systems that provide operational oversight for communication networks that may include a satellite communication link, which provides a transport for information flows between the supervising system and the communication network. The present invention is particularly, but not necessarily, useful as a software-based technology framework for providing information that is needed to maintain the operational integrity and viability of individual or combined satellite and wireless communication networks.

### BACKGROUND OF THE INVENTION

There are at least two essential operating requirements for any communication network. For one, each operational component of the network must be effectively incorporated into the network. There is then the further requirement to monitor and maintain the overall operational integrity of the network, as well as the viability of each constituent component in the network.

With the above in mind, it will be appreciated that for a global communication network to be truly effective, on either a local or global scale, it should be continuously monitored and operationally evaluated. This necessarily requires a two-way transfer of information through the entire network. In one direction, this involves the transfer of operational information from each individual operating component in a communication network to a network manager in a supervising system. Based on the operational information, support information can then be generated by the supervising system. The support information is then provided by the network manager for dissemination in the other direction for use in the support and maintenance of the communication network.

For purposes of the present invention, the following functional descriptions are presented for disclosure and reference purposes.
“Supervising System” means a universal software-based technology framework that provides an oversight capability for monitoring the state/status and performance characteristics of individual components in a communication network. The supervising system also provides reports for use in coordinating the configuration and replacement or corrective changes that are necessary to maintain the operational integrity and viability of a communication network. A coordinated operation of the supervising system is conducted by a network manager.
“Communication Network” means any combination of software and/or hardware components that together provide a communication capability between a myriad of dispersed and distributed hosts (e.g., terminals and servers). In general, communication networks include components such as antennas, modems, navigation units, sensors, and electronic machines that are interconnected with a host for diverse data management and/or data transmission requirements.
“Operational Information” means data that pertains to the operational state/status and performance capability of a network component. This also includes fault reporting on a component's operational capability. In use, operational information is transmitted from hosts in a communication network to the network manager in the supervising system.
“Support Information” means data pertaining to configuration replacement and corrective changes for implementation by components in a communication network. Support information is based on operational information, and is provided by the supervising system directly to hosts and their connected components in the communication network(s). More specifically, support information is based on operational information from the communication network(s), and results from the correlation and analysis of data in the operational information. In general, support information pertains to administration, configuration, provisioning and troubleshooting issues that affect components of a communication network.

In light of the above, it is an object of the present invention to provide a software-based supervising system for supporting a combined wireless and satellite communication network. Another object of the present invention is to provide a software-based supervising system for supporting a combined wireless and satellite communications network that effectively provides both operational oversight and management functions using a two-way information flow between the supervising system and a communication network. Still another object of the present invention is to provide a monitoring and fault diagnostic capability for a global communications network, which may include a satellite link. Yet another object of the present invention is to provide a system and method for employing a software-based technology framework to manage and oversee a combined wireless and satellite communication network that is easy to maintain, is simple to operate, and is cost effective.

### SUMMARY OF THE INVENTION

In accordance with the present invention, a system and method are provided for using a software-based technology framework (i.e. supervising system) to oversee and manage a combined wireless and satellite communication network. For the present invention this requires a two-way information flow between the supervising system and the communication network. In particular, this two-way information flow employs a network manager in the supervising system to monitor all of the operative components in the communication network by receiving operational information from these components. The supervising system then correlates and analyzes the operational information (i.e. data) to generate support information that will be sent to appropriate components in the communication network(s). In some instances, this dissemination of support information may preferably be made via a satellite or wireless link.

Within the context of the present invention, the operational information that is provided to the supervising system for correlation and analysis comes from individual operative components of a communication network. In general, this information will include information that is currently relevant to the state/status, performance, and fault reporting condition of the particular component, as well as its cooperation with other components. In particular, the operational information selectively pertains to functional aspects of components and subsystems in the communication network that can affect the overall configuration and/or operability of the network. Of interest here are such aspects as the operability of Global Positioning System (GPS) subsystems, navigation subsystem components, component operation, software upgrades, the efficiency of statistical data collection and overall network configuration, as well as system startup and recovery.

As noted above, the support information that is disseminated from the supervising system to the operating components of the communication network will generally include information pertaining to administration, configuration, provisioning and troubleshooting. For example, the support information may include directives for performing administrative tasks, details for establishing system component configurations, instructions for provisioning the system, and suggestions for troubleshooting.

As envisioned for the present invention, the interactive functional entities of a supervising system and a communication network include a network manager in the supervising system, and a plurality of platform servers that connects the network manager with individual service platforms in the communication network. In this combination, the network manager performs the general function of managing and supervising components in the communication network(s). This is done through the platform servers and the various service platforms. For this purpose, the network manager has a centralized master database that contains information that is pertinent to a comprehensive overall centric view of the communication network(s). On the other hand, each platform server provides a so-called partition view of a predefined portion of the communication network. Within this partition view, each platform server can be interconnected with a plurality of service platforms and, in turn, each service platform can be connected with at least one peripheral and serve as a terminal. In this context, each service platform is concerned with its own remote view of the operating network. Specifically, this includes only the management and operation of itself and its connected peripherals. As envisioned for the present invention, a satellite can be used to provide a communication link between each of the platform servers and a respective plurality of predetermined service platforms in the communication network, if required. The satellite link can also be used for communication between different service platforms.

The flexibility and universality of the present invention are underscored by the adaptability of the supervising system. In particular, the supervising system of the present invention is based on an open standards technology that is compatible with a plethora of different types and configurations of machine networks, for use in many different applications. Further, the supervising system provides an appropriate variety of Application Programming Interface (API) connections for integrating a communication network with the supervising system. With this last point in mind, it is to be appreciated that the present invention also envisions an integration of one supervising system with a plurality of different communication networks, or even with another supervising system.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic depiction of information (data) flow in an operation of the present invention;

FIG. 2 is a schematic presentation of the cooperative interaction between functional components in accordance with the present invention;

FIG. 3 is a diagram of the management plane and the operational plane representing component links in communication flow channels for the monitoring and management of a communication network;

FIG. 4 is a diagram of a management framework for implementing and controlling communication flows in accordance with the present invention; and

FIG. 5 is a logic flow chart for a software-based technology framework that controls and governs a combined satellite and wireless communication network in accordance with the present invention.

### DESCRIPTION OF THE PREFERRED EMBODIMENTS

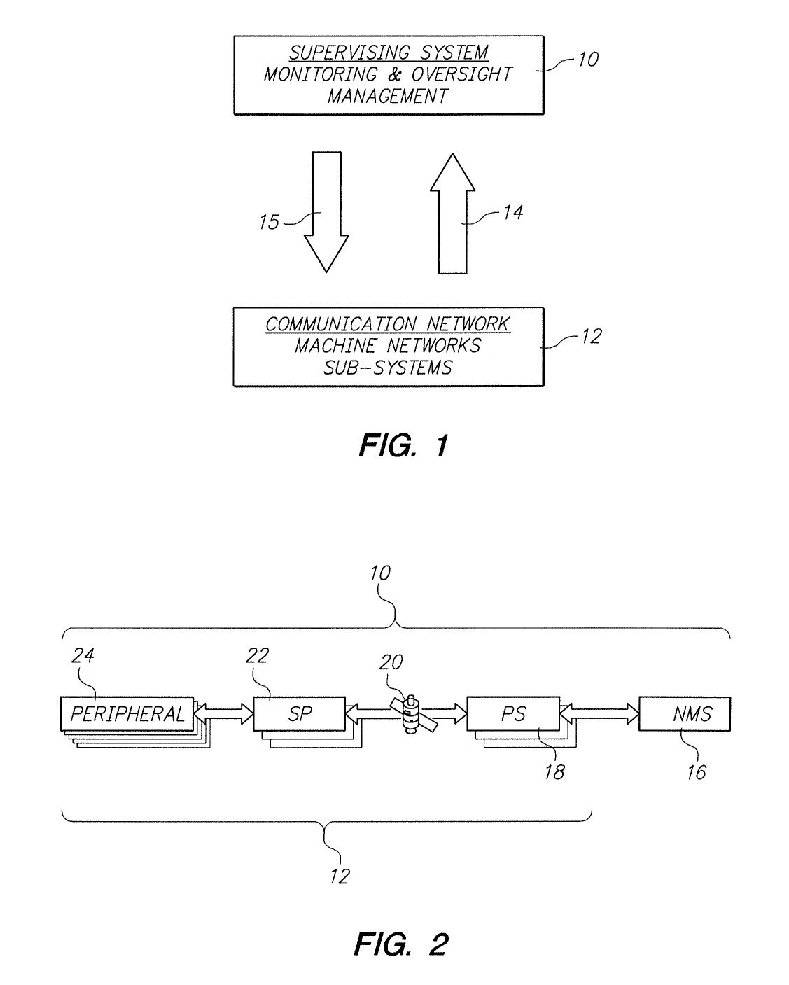

Referring initially to FIG. 1, an operational overview of the present invention is provided to show the flow of information (data) between a supervising system 10 and a communication network 12. As shown, the present invention requires the two-way transmission (flow) of information (data) between the supervising system 10 and the communication network 12. In one direction, operational information 14 is provided from the communication network 12 to the supervising system 10, and in the other direction, support information 15 is provided to components of the communication network 12. In the context of the present invention, the operational information 14 and the support information 15 are interactive. With this in mind, as envisioned for the present invention a supervising system 10 is capable of supporting several communication networks 12. Further, a supervising system 10 is also capable of supporting another supervising system 10′ (not shown).

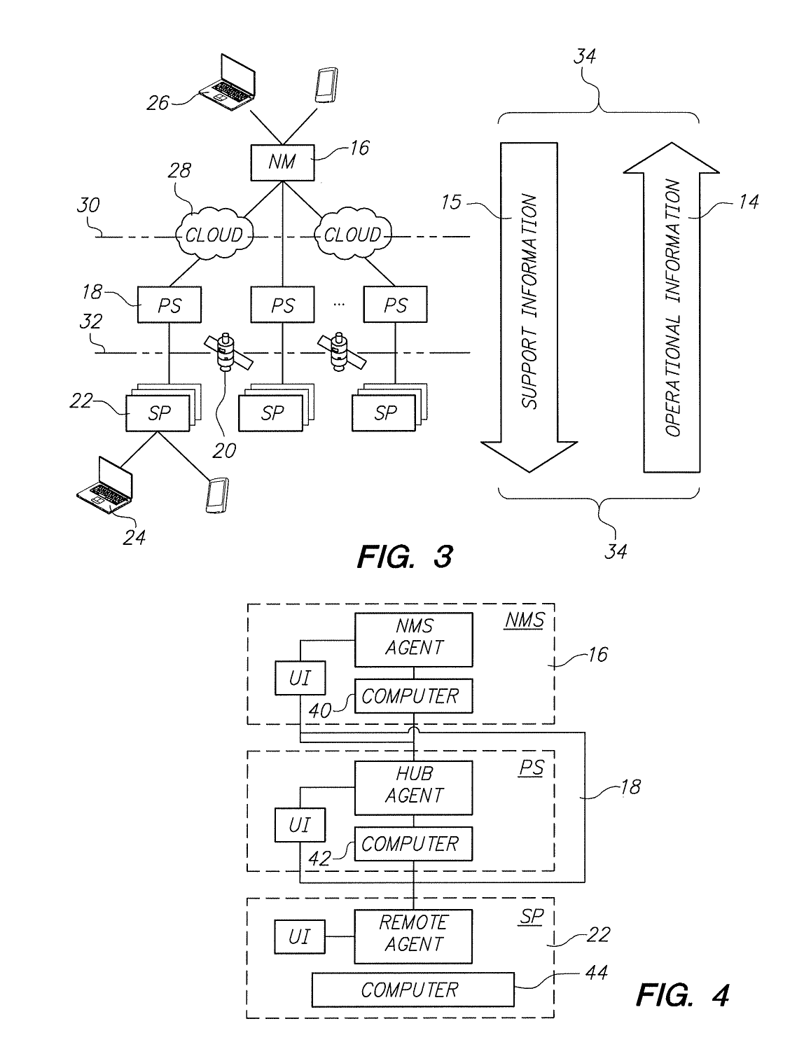

Referring now to FIG. 2, the cooperative interaction between a supervising system 10 and a communication network 12 is shown as a combination of hardware components. From a structural perspective, the supervising system 10 includes a network manager 16 that exercises overall management control of the communication network 12. As interchangeably identified herein, the network manager 16 may in some contexts be referred to as a network management system (NMS). In either case, as shown in FIG. 2, the network manager 16 is connected directly to a platform server(s) 18. For purposes of the present invention, the connection(s) between the network manager 16 and the platform server(s) 18 may be either by landline or they may be wireless. A satellite 20 is also envisioned as part of the communication network 12 for connecting each platform server 18, via a satellite link 32 (see FIG. 3), to a respective service platform(s) 22. The use of a satellite link 32 is, however, optional. In either case, each service platform 22 then supports a specified peripheral(s) 24.

Within the combination of operational componentry set forth above, the network manager 16 of the supervising system 10 effectively provides an oversight function that monitors the entire communication network 12. Thus, the supervising system 10 operationally extends from the network manager 16 (e.g. from a peripheral 26 at the network manager 16: see FIG. 3), to a peripheral 24 that is operating with a service platform 22. On the other hand, insofar as the communication network 12 is concerned, with the exception of the network manager 16, it is effectively coextensive with the supervising system 10. The importance of this essentially coextensive overlap is based on the necessity for an interactive two-way flow of information at all points between the supervising system 10 and the communication network 12 as indicated in FIG. 1.

Referring now to FIG. 3, it is to be appreciated that the wireless section of the communication network 12 is represented by the cloud 28. For purposes of the present invention, the cloud 28 represents the myriad of possible non-satellite communications links 30, including land lines, that may be individually established between the network manager 16 and a selected one of the various platform servers 18. To complete connections through the communication network 12, the satellite 20 may be optionally employed to establish a satellite link 32 between a platform server 18 and a predetermined service platform 22. Recall, each service platform 22 may then be connected with a plurality of peripherals 24. Together, the plurality of communications links 30 and the plurality of respective satellite links 32 establish a communications flow channel 34 which is to be used by the network manager 16 for the management, monitoring and oversight function that are necessary for the operational viability of the communication network 12.

As shown in FIG. 3, the communications flow channel 34 effectively establishes the required two-way communication that is necessary for the present invention. In detail, support information 15 is directed in the communications flow channel 34 from the network manager 16. Specifically, the support information 15 is directed in the communication flow channel 34 to both platform servers 18 and their respective service platforms 22 with associated peripherals 24. On the other hand, operational information 14 is directed in the communications flow channel 34 toward the network manager 16. In this case, the operational information 14 is provided from both the platform servers 18 and the service platform(s) 22.

In general, support information 15 from the network manager 16 will include information pertaining to administration, configuration, provisioning and troubleshooting. Further, the support information 15 may include directives for performing administrative tasks, details for establishing system component configurations, instructions for provisioning the system, and suggestions for troubleshooting. In contrast, the operational information 14 that is sent to the network manager 16 will typically include information (i.e. data) pertaining to state/status, performance, and fault reporting respectively from the platform servers 18, the service platform(s) 22, and the peripherals 24. In greater detail, this operational information 14 may selectively pertain to controls for managing any of the following: a Global Positioning System (GPS), navigation unit, system component operation, software upgrade, statistical data collection, network configuration, system startup and recovery.

In FIG. 4, a computer 40 is shown as a component of the network manager 16. Functionally, the computer 40 receives operational information 14 from the service platform 22 and from the platform server 18. The network manager 16 (i.e. computer 40) then incorporates this operational information 14 into a centralized master database. At the network manager 16, the computer 40 then correlates and analyzes data in the operational information 14 to support and define a centric view for the communication network 12. In particular, this centric view focuses on the operational capabilities of the entire communication network 12. Further, using data from its centralized master database, the computer 40 of network manager 16 generates support information 15 for the various operational components in the communication network 12 (e.g. platform servers 18, service platform(s) 22 and peripherals 24). This support information 15 is then selectively transmitted from the network manager 16 to a platform server 18 and, as appropriate, portions of the support information 15 are further transmitted from the platform server 18 to a service platform 22, via the satellite 20. Thus, the support information 15 is used for governing the network (supervising system) 10.

FIG. 4 also indicates that each platform server 18 includes a computer 42 that hosts configuration and provisioning information for the service platform 18. The computer 42 is also used for collecting statistical data from the service platform(s) 22. With these capabilities, the computer 42 essentially presents a partition view of the communication network 12 which focuses on maintaining effective communications between the network manager 16 and a predefined portion of the communication network 12. FIG. 4 also indicates that each of the service platform(s) 22 will include a computer 44 for retrieving configuration and provisioning information from the platform server 18. The computer 44 is also used for reporting events and statistical data to the platform server 18, and for connecting the service platform(s) 22 with a peripheral 24 in the operational information 14.

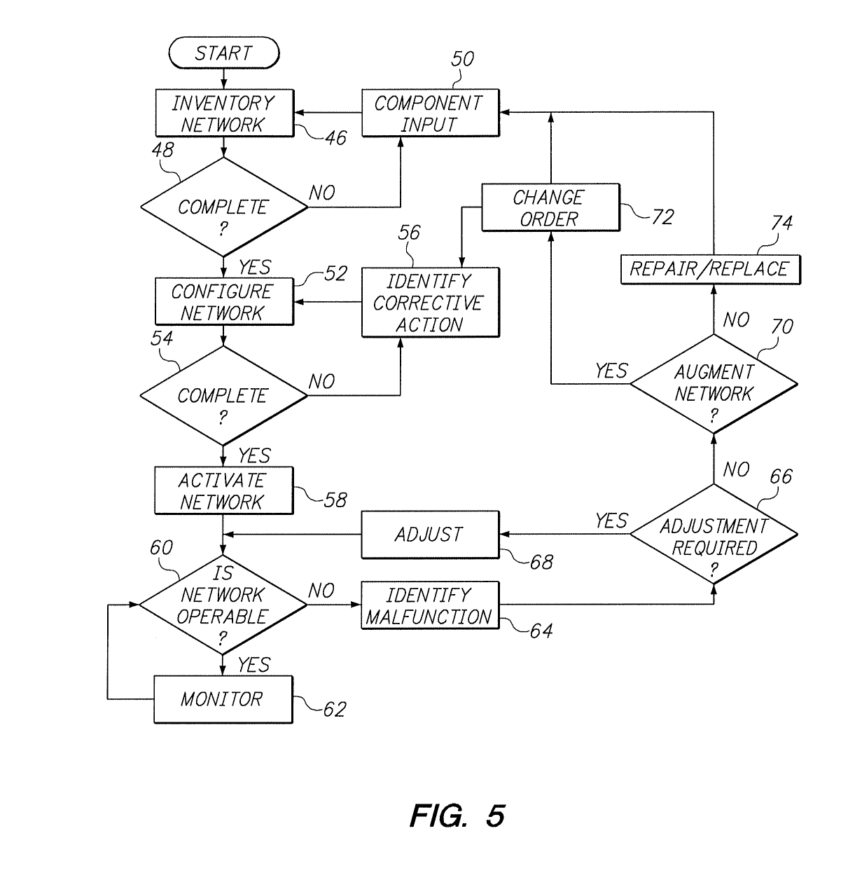

From the perspective of the network manager 16, an operation of the supervising system 10 is to be appreciated by reference to the logic flow chart presented in FIG. 5. There it will be seen that the action block 46 indicates the first task of the network manager 16 is to inventory the communication network 12. Specifically, this requires determining whether the operational components of the communication network 12 (e.g. platform servers 18, service platform(s) 22 and peripherals 24) are properly accounted for. Inquiry block 48 oversees this determination. If a component is not accounted for, action block 50 indicates that a component needs to be properly provided or replaced. However, if the inventory is complete, action block 52 indicates that the communication network 12 needs to be appropriately configured.

Inquiry block 54 indicates that if a configuration of the communication network 12 is not completed, appropriate corrective action needs to be taken (see action block 56). On the other hand, once a configuration of the communication network 12 has been completed, action block 58 indicates that the communication network 12 can be operationally activated. Once the communication network 12 is activated, and inquiry block 60 indicates that the communication network 12 is operable, the network manager 16 proceeds to continuously monitor the communication network 12 (see action block 62). Within this framework, the functional actions of taking inventory (block 46), establishing a network configuration (block 52), and monitoring the operation of the communication network 12 (block 62) are all essentially accomplished in response to support information 15 within the communication network 12.

During an operation of the communication network 12, whenever a malfunction is somewhere identified (block 64), and an adjustment is required (see inquiry block 66), an appropriate adjustment is made (see action block 68). However, if an adjustment is not required, inquiry block 70 will then determine whether an augmentation of the communication network 12 is necessary. If so, a change order is made (see block 72) and either an appropriate component is provided (block 50) or a corrective action is taken (block 56). On the other hand, if an augmentation is not required, action block 74 indicates that either a repair or replacement of an operational component is required. Within this framework, the functional aspects of making an adjustment within the communication network 12 (block 68), implementing a change order (block 72), and repairing or replacing a defective component (block 74) are all essentially accomplished in response to support information 15 provided by the network manager 16.

While the particular software-based technology for use in monitoring and managing a communication network as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A software-based technology framework for supervising and supporting a communications network, wherein the software-based technology framework comprises:
a supervising system for receiving operational information from operative components in the communications network; and
a network manager, established in the supervising system, for disseminating support information to the operative components of the network, wherein the support information is derived from the operational information and is used by the operative components of the network to maintain the operational integrity and viability of the network.

2. A software-based framework as recited in claim 1 wherein the operational information includes information pertaining to state/status, performance, and fault reporting from the operative components.

3. A software-based framework as recited in claim 2 wherein the operational information selectively pertains to functional aspects affecting a collective operability of components in the communication network, to include Global Positioning System (GPS) subsystems, navigation subsystems, software upgrades, statistical data collection efficiencies, overall network configuration, system startup, and system recovery.

4. A software-based framework as recited in claim 1 wherein the support information includes information pertaining to administration, configuration, provisioning and troubleshooting.

5. A software-based framework as recited in claim 2 wherein the support information further includes directives for performing administrative tasks, details for establishing system component configurations, instructions for provisioning the system, and suggestions for troubleshooting.

6. A software-based framework as recited in claim 1 wherein the network manager comprises:
a centralized master database; and
a computer with a computer program product having program sections for respectively correlating data in the operational information, analyzing the correlated data to produce operational intelligence, and providing reports based on the operational intelligence for dissemination to selected operative components in the communication network for use in coordinating replacements and corrective changes in the network configuration.

7. A software-based framework as recited in claim 6 wherein the communications network comprises:
a plurality of platform servers;
a plurality of service platforms; and
at least one peripheral connected to each service platform.

8. A software-based framework as recited in claim 7 wherein operational information about the peripheral and the service platform is passed from the service platform to the network manager, and operational information about the platform server is passed from the platform server to the network manager and is incorporated into the centralized master database to generate support information for selective transmissions of the support information from the network manager to the platform server, to the service platform, and to the peripheral, for respective use in maintaining the communication network.

9. A software-based framework as recited in claim 1 having a plurality of communication networks, and wherein the framework further comprises a wireless link for use in connecting the network manager of the supervising system with operative components in any communication network, and for use in connecting an operative component in one communication network with an operative component in another communication network.

10. A software-based framework as recited in claim 9 further comprising:
a first computer with the network manager having a computer program product with program sections for presenting an overall centric view of the network, for providing additional data to the centralized master database, for directly managing and for controlling the platform server, and indirectly managing the service platform;
a second computer with the program server having a computer program product with program sections for presenting a partition view of the communication network, and for directly managing and controlling the service platforms; and
a third computer with each service platform having a computer program product with program sections for presenting a remote view of the communications network, for retrieving configuration and provisioning information from the platform server, and for reporting events and statistical data to the platform server.

11. A supervising system for a communications network, wherein the communications network includes a plurality of platform servers and a plurality of service platforms, wherein the supervising system is a software-based technology framework and comprises:
a network manager;
a first plurality of electronic connections for passing operational information in a communication flow channel from the service platforms and from the platform servers to the network manager, wherein the operational information selectively includes data on state/status and performance levels of components in the communications network, and inspection reports on detected faults in the communications network, and wherein the operational information is received and maintained as data in a centralized master database at the network manager;
a computer connected with the network manager, wherein the computer correlates and analyzes data of the operational information to generate support information; and
a second plurality of electronic connections for passing the support information in the communication flow channel from the network manager to the service platforms and to the platform servers, wherein the support information comprises directives for performing administrative tasks, details for establishing system component configurations, instructions for provisioning the system, and suggestions for troubleshooting.

12. A supervising system as recited in claim 11 wherein the communications flow channel comprises:
a plurality of first communication links, wherein each first communication link connects the network manager with a respective platform server for disseminating support information from the network manager and for providing operational information to the network manager; and
a plurality of second communication links, wherein each second communication link is a satellite link between a platform server and at least one service platform, for disseminating support information to the service platform and for providing operational information from the service platform.

13. A supervising system as recited in claim 12 wherein the support information includes information pertaining to administration, configuration, provisioning and troubleshooting, and is provided for performing administrative tasks, details for establishing system component configurations, instructions for provisioning the system, and suggestions for troubleshooting.

14. A supervising system as recited in claim 12 wherein the operational information includes information pertaining to state/status, performance, and fault reporting from the operative components, and is provided for managing a Global Positioning System (GPS), navigation, system component operation, software upgrade statistical data collection, network configuration, system startup and recovery.

15. A supervising system as recited in claim 12 further comprising:
a satellite link incorporated into the communication network between the plurality of first communication links and the plurality of second communication links; and
at least one peripheral connected to each service platform.

16. A method for supervising and supporting a communications network which comprises the steps of:
establishing a two-way communications flow channel between a network manager and a plurality of operative components in the communication network;
monitoring the operative components of the communication network to receive operational information from the operative components at the network manager, wherein the operational information includes information pertaining to state/status, performance, and fault reporting from the operative components;
correlating and analyzing data in the operational information to generate support information; and
disseminating the support information to the operative components of the communication system, wherein the support information includes information pertaining to administration, configuration, provisioning and troubleshooting of the pertinent operative component.

17. A method as recited in claim 16 wherein the operative components of the flow channel includes a platform server, a service platform and a terminal.

18. A method as recited in claim 17 wherein the communications channel incorporates a wireless link.

19. A method as recited in claim 17 wherein the operational information selectively pertains to functional aspects of components and subsystems in the communication network that can affect the overall configuration and/or operability of the network, and wherein the functional aspects include the operability of Global Positioning System (GPS) subsystems, navigation subsystem components, software upgrades, efficiency of statistical data collection, overall network configuration, and system startup and recovery.

20. A method as recited in claim 17 wherein the support information includes information pertaining to administration, configuration, provisioning and troubleshooting, to further include directives for performing administrative tasks, details for establishing system component configurations, instructions for provisioning the system, and suggestions for troubleshooting.
